(19) United States
(12) Patent Application Publication
(10) Pub. No.: US 2026/0275786 A1
(43) Pub. Date: Sep. 17, 2026

(54) Sliding Door Device

(71) Applicant: ARLU, Ardooie (BE)

(72) Inventors: Jean-Michel Philippe Jean-Paul BUESS, Brugge (BE); Tom HOUTHOOFD, Roeselare (BE)

(21) Appl. No.: 19/473,932

(22) PCT Filed: Apr. 10, 2024
(86) PCT No.: PCT/IB2024/053502

§ 371 Date: Oct. 9, 2025

(30) Foreign Application Priority Data
Apr. 14, 2023 (BE) BE2023/5280

(51) Int. Cl. E05D 15/06

(52) U.S. Cl. CPC E05D 15/063; E05Y 2201/684; E05Y 2900/132

(57) ABSTRACT

A sliding door device comprises a support profile and a runner mounted rollably therein and configured for suspending therefrom a door leaf. The runner comprises at least two wheels manufactured by an injection moulding process. Each wheel comprises a core part; a rim part; spokes between the core part and the rim part; and an intermediate part between the core part and the rim part, in which the intermediate part is manufactured from a softer material than the core part and the rim part and encloses the spokes. The softer intermediate part dampens vibrations generated by the rolling of the wheels along the support profile and thus dampens the transmission of vibrations between the rim part and the door leaf such that noise is dampened. The hard rim part reduces the risk of deformation of the rim due to the weight of the door leaf. The spokes provide a mechanical connection between the core part and the rim part as well as mechanical anchoring of the intermediate part.

### TECHNICAL FIELD

The present invention relates to a sliding door device. More specifically, the present invention relates to sliding door devices in which the door leaf is suspended on its upper side from a runner in a support profile.

### PRIOR ART

Known suspended sliding door devices comprise a support profile intended to be firmly fastened to a wall or ceiling in a room. This can be either direct fastening where the support profile is fastened to the wall or ceiling by means of conventional fastening means (bolts, gluing, etc.) or indirect fastening where the support profile is fastened to the wall or ceiling by means of an intermediate connection profile. One or more runners are mounted in the support profile and can be rolled therein by means of one, but typically multiple, wheels per runner. The door leaf is suspended from the runners via its upper side. For this purpose, use is typically made, for each runner, of a mounting bracket on the upper side of the door leaf and a bolt (or the like) that firmly connects the runner to the corresponding mounting bracket.

A known problem with such suspended sliding door devices is the noise caused by the sliding of the door leaf. More specifically, the rolling of the runner creates oscillations/vibrations which, via the bolts and the mounting brackets, are transmitted to the door leaf, thus forming a source of (disturbing) noise.

This problem has already been addressed in patent application EP 3 517 718 A1. Therein, a sliding door device is generally disclosed which comprises: a support profile and at least one runner mounted rollably in the support profile and configured for suspending therefrom a door leaf of the sliding door device, which runner comprises a body to which at least two wheels are fastened, wherein the wheels are manufactured by an injection moulding process. For damping the vibrations, EP 3 517 718 A1 discloses providing an elastomeric filler between the bolt and the body of the carriage to thus reduce transmission of the vibrations to the door leaf.

This issue was also addressed in publications DE 10 2012 105 182 A1 and DE 20 2017 002 962 U1, which both disclose a wheel for a sliding door device, which wheel is provided with: a core part manufactured from a first thermoplastic material having a first hardness; a rim part manufactured from a second thermoplastic material having a second hardness; and an intermediate part extending between the core part and the rim part and manufactured from a third thermoplastic material having a third hardness, wherein said third hardness is lower than both said first hardness and said second hardness.

### DESCRIPTION OF THE INVENTION

It is an object of the present invention to provide an improved solution for damping noise during the sliding of a door leaf of a sliding door device.

This object is achieved, on the one hand, by the fact that each wheel is provided with: a core part manufactured from a first thermoplastic material having a first hardness; a rim part manufactured from a second thermoplastic material having a second hardness; and an intermediate part extending between the core part and the rim part and manufactured from a third thermoplastic material having a third hardness, wherein said third hardness is lower than both said first hardness and said second hardness, and on the other hand by the fact that each wheel is further provided with spokes between the core part and the rim part, wherein the intermediate part encloses each of the spokes.

According to the present invention, the wheels of the runner are composed of three different parts, namely a hard core part and a hard rim part with a softer intermediate part between them. The softer intermediate part damps vibrations between the rim part (i.e. the source of vibrations) and the core part connected to the body of the runner. In this way, the transmission of vibrations between the rim part and the door leaf is reduced and thus noise is also damped.

The use of two (or more) wheels therefore provides two (or more) areas for damping of vibrations compared to the one area where vibrations are damped as known from EP 3 517 718 A1. Greater damping can thus be achieved by having more damping areas and/or damping material available.

Even greater damping could be obtained by manufacturing the wheels entirely from a soft material. However, this may lead to deformation of the wheels due to the possibly high weight of the door leaf; typically, door leaves in this application weigh 40 kg to 60 kg, but door leaves weighing up to 100 kg or even exceptionally 150 kg or 200 kg are possible. The door leaf is typically very often in one of two resting positions (i.e. door open or door closed) such that the wheels are largely supported by the support profile in one or two locations along their rim part. However, a soft plastic tends to deform locally as a result of continuously bearing this weight and can thus lead to wheels with one or two flat parts, which is obviously undesirable and drastically disrupts the operation of the sliding door device. Making the rim part out of a hard plastic avoids or reduces the chance of such deformation.

Manufacturing the core part from a hard material is also desirable because this part serves for coupling to the body of the runner and should therefore be able to bear the necessary forces.

The spokes further provide a mechanical connection between the core part and the rim part as well as mechanical anchoring of the intermediate part. This allows the different parts, in particular the intermediate part on the one hand and the core part and rim part on the other hand, to be manufactured from plastics that are not chemically compatible. This thus increases the choice of materials and allows the hardness/softness of the materials to be chosen more freely for optimal damping without having to take chemical compatibility into account.

In an embodiment of the present invention, each spoke extends in a longitudinal direction which is at an angle relative to a radial direction, which angle is preferably between 30°and 70°, which angle is in particular at least 40°, more particularly at least 45° and most particularly at least 50°, which angle is in particular at most 60° and more particularly at most 55°. To achieve damping of the vibrations, it is necessary that the rim part and the core part can move relative to each other in the radial direction. Placing the spokes at an angle relative to the radial direction allows them to bend under the influence of vibrations in the rim part in order to allow movement of the rim part relative to the core part. Such bending would not be possible with spokes that extend in the radial direction such that they would have to be manufactured from a softer material (compared to the rim part). The angle is optimised to firstly allow sufficient bending, for which the angle is preferably as large as possible, and also to minimise the total opening angle over which the spoke extends, for which the angle is preferably as small as possible.

In an embodiment of the present invention, the intermediate part substantially completely fills the volume between the core part and the rim part. First, this simplifies the injection moulding process as no elements need to be provided in the injection moulding machine that occupy a part of the intermediate volume. In addition, there is thus as large a volume of soft material as possible, which improves damping.

In an embodiment of the present invention, the spokes are manufactured from a fourth thermoplastic material having a fourth hardness, wherein said third hardness is lower than said fourth hardness. The hardness of the spokes is of minor importance since, as already described above, the spokes serve mainly to mechanically anchor the core part, the rim part and the intermediate part. Preferably, said fourth thermoplastic material is one of the following: a polybutylene terephthalate (PBT); and a polyoxymethylene (POM). The various possible materials additionally provide the necessary flexibility in terms of design and allow other factors (besides hardness) to be taken into account when designing the wheels, e.g. cost, sensitivity to wear, appearance, etc.

In an embodiment of the present invention, the core part, rim part and spokes are integrally manufactured from the same thermoplastic material. This simplifies the injection moulding process and also prevents problems that may occur by manufacturing these parts separately and subsequently coupling them to each other (e.g. partial or complete detachment of certain parts at a later time).

In an embodiment of the present invention, said first thermoplastic material and/or said second thermoplastic material is one of the following: a polybutylene terephthalate (PBT); and a polyoxymethylene (POM). The various possible materials additionally provide the necessary flexibility in terms of design and allow other factors (besides hardness) to be taken into account when designing the wheels, e.g. cost, sensitivity to wear, appearance, etc.

In one embodiment of the present invention, the intermediate part is manufactured integrally. This simplifies the injection moulding process and also prevents problems that may occur by manufacturing the intermediate part separately from multiple components and subsequently coupling them to each other (e.g. partial or complete detachment of certain parts at a later time).

In an embodiment of the present invention, said third thermoplastic material is one of the following: a thermoplastic elastomer (TPE), in particular a thermoplastic polyurethane (TPU); a polyamide (PA); a thermoplastic polyester, in particular a polybutylene terephthalate (PBT); and a polyoxymethylene (POM). The various possible materials additionally provide the necessary flexibility in terms of design and allow other factors (besides hardness) to be taken into account when designing the wheels, e.g. cost, sensitivity to wear, appearance, etc.

In an embodiment of the present invention, said first hardness and/or said second hardness is at least 60 shore D, which hardness is in particular at least 70 shore D, more particularly at least 75 shore D and most particularly at least 80 shore D, wherein the hardness is determined according to ISO 868:2003. Such a hardness makes it possible to obtain a sufficiently hard rim part so as to avoid deformation due to the weight of the door leaf as indicated above.

In an embodiment of the present invention, said third hardness is between 35 shore D and 80 shore D, which hardness is in particular at least 40 shore D, more particularly at least 45 shore D and most particularly at least 50 shore D, which hardness is in particular at least 70 shore D, more particularly at least 65 shore D and most particularly at least 60 shore D, wherein the hardness is determined according to ISO 868:2003. Such a hardness makes it possible to obtain a sufficiently soft rim part for damping of vibrations.

In an embodiment of the present invention, said third hardness is between 30% and 90%, in particular between 50% and 80%, of said first hardness and/or of said second hardness. Such a difference in hardness is sufficient for the desired damping of the vibrations.

In an embodiment of the present invention, each wheel is fastened to the body by means of an axle, wherein the body is provided, for each axle, with a bearing in which the axle is fastened. The bearing ensures smooth rotation of the wheels, i.e. rotation with little friction.

In an embodiment of the present invention, the sliding door device further comprises a damper placed in the support profile for damping a final movement of said at least one runner. Preferably, the damper is provided at one end thereof with a magnetic element and said at least one runner comprises a magnetic element, wherein said at least one runner is temporarily fastened at least during its final movement to the damper by magnetic attraction between the magnetic elements. The damper damps the closing movement of the door leaf, which closing movement, in the absence of the damper, may cause noise and/or damage. Integrating this damper into the support profile further limits the space needed to fit the sliding door device. This is because at present, such a damper is typically placed next to (e.g. under) the support profile. The use of the magnetic elements (e.g. two permanent magnets or one permanent magnet and a ferromagnetic element) contributes to the desired placement of the door leaf in the open position of the sliding door (e.g. flush with a wall of a door opening). More particularly, a known problem is that after damping, the door leaf shifts over a small distance in the opposite direction and thus does not rest in the correct place.

### BRIEF DESCRIPTION OF THE DRAWINGS

The invention will be explained in further detail below with reference to the following description and to the accompanying drawings.

FIG. 1 shows a general view of an upper part of a sliding door device according to the present invention.

FIGS. 2A and 2B show perspective views of the underside and upper side, respectively, of the runner present in a sliding door device according to the present invention.

FIGS. 3A to 3C show various views of a base body of a wheel of the runner present in a sliding door device according to the present invention.

FIGS. 4A to 4C show the same views as those of FIGS. 3A to 3C, respectively, of a wheel of the runner present in a sliding door device according to the present invention.

### EMBODIMENTS OF THE INVENTION

The present invention will be described below using specific embodiments and with reference to certain drawings, but the invention is not limited thereto and is defined only by the claims. The drawings shown herein are only schematic representations and are not limiting. In the drawings, the dimensions of certain components may be shown enlarged, meaning that the components in question are not shown to scale, for illustrative purposes only. The dimensions and relative dimensions do not necessarily correspond to the actual practical implementations of the invention.

In addition, terms such as “first”, “second”, “third” and the like are used in the description and in the claims to distinguish between similar elements and not necessarily to indicate a sequential or chronological order. The terms in question are interchangeable under appropriate circumstances and the embodiments of the invention may operate in different orders than those described or illustrated herein.

Moreover, terms such as “left”, “right”, “front”, “rear” and the like are used in the description and in the claims for descriptive purposes. The terms thus used are interchangeable under appropriate circumstances and the embodiments of the invention may operate in different orientations than those described or illustrated herein.

Terms such as “top”, “bottom”, “upper” , “under” and the like are used in the description and in the claims for descriptive purposes with reference to the usual orientation of the sliding door device in which the support profile is located above the door leaf.

The term “comprising” and derived terms, as used in the claims, should or should not be interpreted as being limited to the means mentioned each time thereafter; the term does not preclude other elements or steps. The term should be interpreted as specifying the listed properties, whole numbers, steps or components referred to, while not precluding the presence or addition of one or more additional properties, whole numbers, steps or components, or groups thereof. Therefore, the scope of an expression such as “a device comprising the means A and B” is not limited to devices consisting solely of components A and B. On the contrary, what is meant is that, as far as the present invention is concerned, the only relevant components are A and B.

The term “substantially” comprises variations of +/−10% or less, preferably +/−5% or less, more preferably +/−1% or less, and even more preferably +/−0.1% or less, from the specified condition, in so far as the variations are applicable for operation in the present invention. It should be understood that the term “substantially A” is intended to also comprise “A”.

FIG. 1 shows a partial view of the upper side of a sliding door device 1. The sliding door device 1 comprises a support profile 2 intended to be firmly fastened to a wall or a ceiling in a room. This can be either direct fastening where the support profile is fastened to the wall or ceiling by means of conventional fastening means (bolts, gluing, etc.) or indirect fastening where the support profile is fastened to the wall or ceiling by means of an intermediate connection profile.

The support profile 2 is typically manufactured from a rigid material. This can be aluminium, for example. Aluminium has advantages as a profile material, as it is simultaneously robust and light, resistant to adverse weather conditions and requires little maintenance. However, other materials are also suitable and their advantages or disadvantages are assumed to be known by the person skilled in the art. The support profile 2 can be produced using various techniques depending on the material, including extrusion, milling, setting, casting, welding, and so on, with extrusion being preferred. The appropriate production technique is assumed to be known by the person skilled in the art.

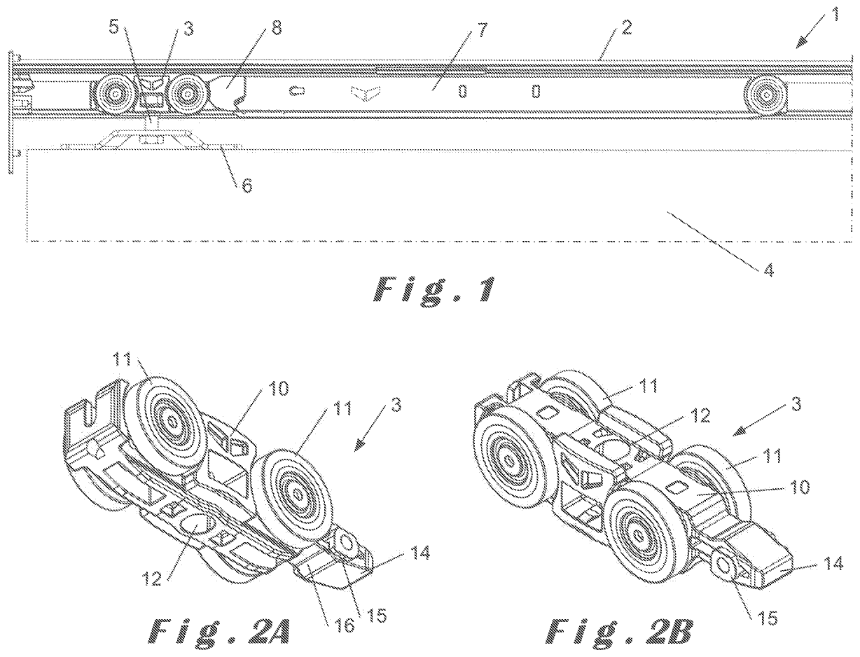

One or multiple runners 3 (shown in more detail in FIGS. 2A and 2B) are arranged in the support profile 2 and can be rolled therein. The door leaf 4 is suspended via its upper side from the runners 3 present. For this purpose, a mechanical connection between the door leaf 4 and the runners 3 is provided. In the embodiment shown, this mechanical connection comprises a mounting bracket 6 fastened to the door leaf and a bolt 5 that serves as a connection between the mounting bracket 6 and a runner 3. Other mechanical connections are of course possible. FIG. 1 shows one runner 3, but it should be clear that in the embodiment shown there is typically also one second runner present near the opposite end of the upper side of the door leaf 4. In this way, the upper side of the door leaf 4 is fastened at both ends to a runner 3.

The door leaf 4 can be made in different materials (e.g. wood, plastic, metal, etc.), shapes (e.g. full, hollow, with openings, etc.), sizes (e.g. width, height, thickness, etc.), etc. according to the wishes and/or needs of the application (e.g. indoors, outdoors, etc.).

The shown runner 3 comprises a generally hook-shaped end 14 forming a stop wall 16. In an embodiment not shown, the hook-shaped end engages in a clamp (not shown) at the end of the support profile 2. In this case, a leaf spring (not shown) is provided that is pushed open by the hook-shaped end 14 and then snaps closed again to hold the hook-shaped end 14. This is a standard stop device for determining the end position of the door leaf 4.

The sliding door device 1 shown further comprises a damper device 7 that cooperates with the runner 3. The damper device 7 is mechanically coupled to the runner 3 via the hook-shaped end 14 and is therefore firmly connected to the runner 3. The damper device 7 thus slides along in the support profile 2. Internally, the damper device 7 is provided with a hydraulic damper and a spring. The spring serves to pull the door leaf 4 into its open or closed position (double-acting) after activation, while the damper dampens this movement. The spring and hydraulic damper are connected in parallel and fitted with a hook on each side. Said hook engages an activator (not shown) that is fastened in the support profile 2 and determines the closing position. The damper device 7 thus forms a soft-close for the end position of the door leaf 4.

In yet another embodiment, a push-open functionality may also be provided. In this case, a user can push the door leaf 4 into its retracted state (i.e. door open) to partially push it out of the door pillar. Such a push-open functionality is known and typically comprises a spring system, e.g. a gas spring, which develops a counter-pressure due to the user pushing in order to push the door leaf 4 out of its end position. In an advantageous embodiment, magnetic elements (e.g. two permanent magnets or one permanent magnet and a ferromagnetic material) are placed on the spring system and on the runner 3. Such additional magnetic coupling contributes to the correct placement of the door leaf 4 in the retracted state.

FIGS. 2A and 2B show the runner 3 used in the sliding door device 1 in more detail. The runner 3 comprises a body 10. Typically, this is manufactured from a rigid plastic, e.g. by injection moulding. However, other materials (e.g. metal) and/or production techniques (e.g. additive manufacturing, also known as 3D printing) are possible.

The body 10 comprises the hook-shaped end 14 already described above. In the embodiment shown 10, the body 14 also comprises a through-opening 12 provided with an internal thread for fastening the bolt 5 thereon. Optionally, in addition to or as a replacement for the internal thread, a nut (not shown) may be provided in the body in line with the through-opening 12 for fastening the bolt 5 thereto. In the embodiment shown, the head of the bolt 5 is positioned under the mounting bracket 6 and the thread of the bolt 5 in the runner 3. However, reversal of the bolt 5 is also possible in other embodiments.

Multiple (four in the embodiment shown) wheels 11 are fastened to the body 10. More specifically, opposite wheels 11 are mounted together on an axle (not shown) that extends through the body 10. A bearing (e.g. a roller bearing, ball bearing, etc.) may, if desired, be present between the axle and the body 10. Alternatively, a bearing may be provided for each wheel 11 between the wheel and the axle. The use of one or multiple bearings ensures smoother rotation of the wheels 11 relative to the body 10. In the embodiment shown, the runner 3 comprises four wheels 11, which improves stability and carrying capacity. However, it is also possible to use only two wheels per runner; these may or may not be coaxial, although non-coaxial placement is desirable for the stability of the runner. More than four wheels per runner is also furthermore possible, as is an odd number of wheels.

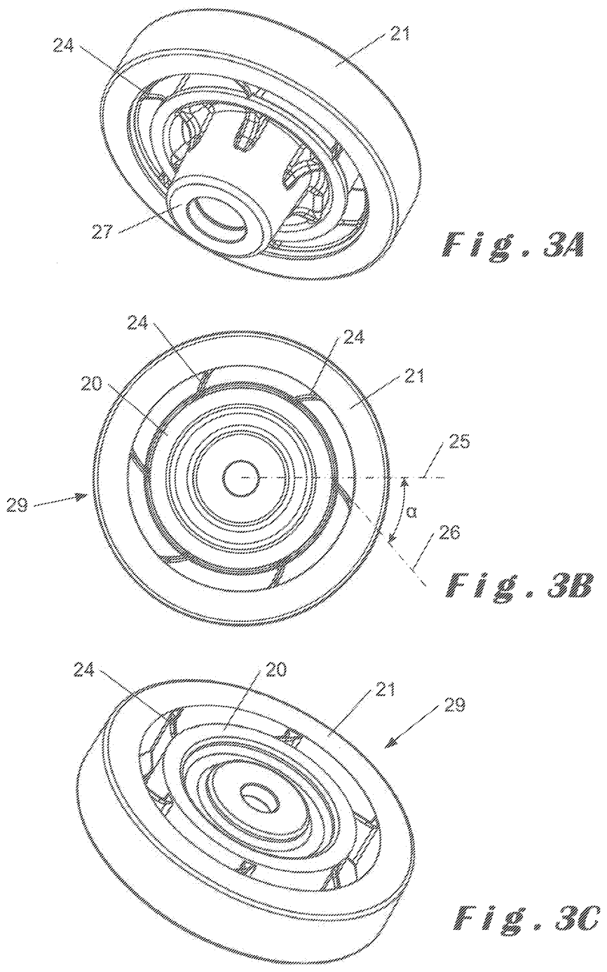

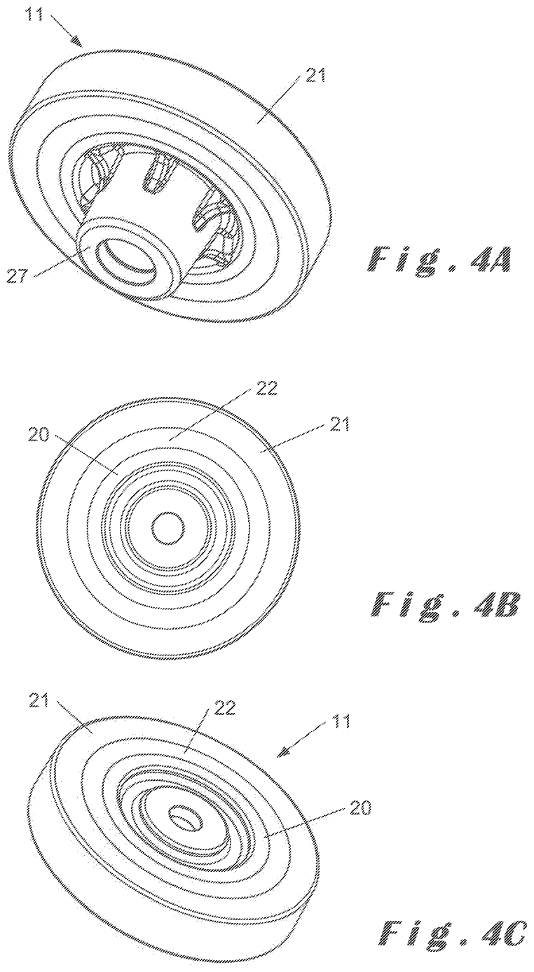

The core of the present invention relates to the construction of the wheels 11 of the runners 3. This construction is described below with reference to FIGS. 3A to 4C. The wheels 11 according to the present invention are manufactured by an injection moulding process from at least a first thermoplastic and a second thermoplastic which have different hardnesses. The wheels 11 of the embodiment shown comprise a base body 29 (shown in FIGS. 3A to 3C) manufactured from a hard plastic, while the finished wheels 11 are shown in FIGS. 4A to 4C.

The base body 29 comprises a core part 20 and a rim part 21 which are connected by spokes 24. The core part 20 forms the inner part of the wheel 11 and, in the embodiment shown, is provided with a hub 27 in which the axle (not shown) serving to connect to the body 10 extends. The rim part 21 is the outer part of the wheel 11 and is in contact with the support profile 2. The spokes 24 serve to provide the mechanical connection between the core part 20 and the rim part 21.

In the embodiment shown, the base body 29 is integrally manufactured from one plastic. Possible plastics are, as described above, a polybutylene terephthalate (PBT); and a polyoxymethylene (POM).

The plastic used to manufacture the base body, in certain embodiments as described above, has a hardness of at least 60 shore D, which hardness is in particular at least 70 shore D, more particularly at least 75 shore D and most particularly at least 80 shore D, wherein the hardness is determined according to ISO 868:2003.

As shown in FIG. 3B, the spokes 24, in the embodiment shown, extend in a direction 26 making an angle a relative to the radial direction 25. This angle a, as described above, is preferably between 30°and 70°, which angle in particular is at least 40°, more particularly at least 45° and most particularly at least 50°, which angle in particular is at most 60° and more particularly at most 55°.

In other embodiments, the base body 29 may be manufactured from plastics of different hardnesses, wherein the core part 20, the rim part 21 and/or the spokes 24 are manufactured from plastics of different hardnesses. A multi-material injection moulding process may be advantageous in this respect.

After the base body 29 is manufactured, each wheel 11 is obtained by adding the intermediate part 22 thereto. This can be done by means of a second injection moulding process following production of the base body 29. Alternatively, the entire wheel 11 can be manufactured in one production step by a multi-material injection moulding process, e.g. via multi-component injection moulding, multi-shot injection moulding or overmoulding.

The intermediate part 22 is integrally manufactured from a plastic. Possible plastics are, as described above, a thermoplastic elastomer (TPE), in particular a thermoplastic polyurethane (TPU); a polyamide (PA); a thermoplastic polyester, in particular a polybutylene terephthalate (PBT); and a polyoxymethylene (POM). The plastic used to manufacture the intermediate body 22 generally has a hardness lower than that used for (parts of) the base body 29. In certain embodiments, as described above, the hardness of the plastic used to manufacture the intermediate part 22 is between about 30% and 90%, in particular between 50% and 80%, of the hardness of the plastic used to manufacture (parts of) the base body 29. The hardness is typically between 35 shore D and 80 shore D, which hardness is in particular at least 40 shore D, more particularly at least 45 shore D and most particularly at least 50 shore D, which hardness is in particular at least 70 shore D, more particularly at least 65 shore D and most particularly at least 60 shore D, wherein the hardness is determined according to ISO 868:2003.

The use of a softer plastic leads to damping of vibrations as described above.

In the embodiment shown, the intermediate part 22 encloses each of the spokes 24 and (substantially) completely fills the volume between the core part 20 and the rim part 21. This ensures proper containment of the spokes 24 and therefore avoids excessive forces (e.g. torsion effects) on the spokes 24 that may occur in the case of spokes that are not completely contained. Completely filling the volume between the core part 20 and the rim part 21 is furthermore simpler compared to this not being completely filled in a multi-material injection moulding process.

Although certain aspects of the present invention have been described with respect to specific embodiments, it is clear that these aspects can be implemented in other forms within the scope of protection as defined by the claims.

1. A sliding door device comprising:
a support profile; and
at least one runner mounted rollably in the support profile and configured for suspending therefrom a door leaf of the sliding door device, which runner comprises a body to which at least two wheels are fastened, wherein the wheels are manufactured by an injection moulding process,
wherein each wheel is provided with: a core part manufactured from a first thermoplastic material having a first hardness; a rim part manufactured from a second thermoplastic material having a second hardness; and an intermediate part extending between the core part and the rim part and manufactured from a third thermoplastic material having a third hardness, wherein said third hardness is lower than both said first hardness and said second hardness, wherein each wheel is further provided with spokes between the core part and the rim part, wherein the intermediate part encloses each of the spokes.

2. The sliding door device according to claim 1, wherein each spoke extends in a longitudinal direction which is at an angle (α) relative to a radial direction, which angle is preferably between 30° and 70°, which angle is in particular at least 40°, more particularly at least 45° and most particularly at least 50°, which angle is in particular at most 60° and more particularly at most 55°.

3. The sliding door device according to claim 1, wherein the intermediate part substantially completely fills a volume between the core part and the rim part.

4. The sliding door device according to claim 1, wherein the spokes are manufactured from a fourth thermoplastic material having a fourth hardness, wherein said third hardness is lower than said fourth hardness.

5. The sliding door device according to claim 4, wherein said fourth thermoplastic material is one of the following: a polybutylene terephthalate;
and a polyoxymethylene.

6. A sliding door device according to claim 1, wherein the core part, the rim part and the spokes are integrally manufactured from the same thermoplastic material.

7. The sliding door device according to claim 1, wherein said first thermoplastic material and/or said second thermoplastic material is one of the following: a polybutylene terephthalate; and a polyoxymethylene.

8. The sliding door device according to claim 1, wherein the intermediate part is manufactured integrally.

9. The sliding door device according to claim 1, wherein said third thermoplastic material is one of the following: a thermoplastic elastomer, in particular a thermoplastic polyurethane; a polyamide; a thermoplastic polyester, in particular a polybutylene terephthalate; and a polyoxymethylene.

10. The sliding door device according to claim 1, wherein said third hardness is between 35 shore D and 80 shore D, which hardness is in particular at least 40 shore D, more particularly at least 45 shore D and most particularly at least 50 shore D, which hardness is in particular at least 70 shore D, more particularly at least 65 shore D and most particularly at least 60 shore D, wherein the hardness is determined according to ISO 868:2003.

11. The sliding door device according to claim 1, wherein said first hardness and/or said second hardness is at least 60 shore D, which hardness is in particular at least 70 shore D, more particularly at least 75 shore D and most particularly at least 80 shore D, wherein the hardness is determined according to ISO 868:2003.

12. The sliding door device according to claim 1, wherein said third hardness is between 30% and 90%, in particular between 50% and 80%, of said first hardness and/or of said second hardness.

13. The sliding door device according to claim 1, wherein each wheel is fastened to the body by means of an axle, wherein the body is provided, for each axle, with a bearing in which the axle is fastened.

14. The sliding door device according to claim 1, wherein the sliding door device further comprises a damper placed in the support profile for damping a final movement of said at least one runner.

15. The sliding door device according to claim 14, wherein the damper is provided at one end thereof with a magnetic element, wherein said at least one runner comprises a magnetic element and wherein said at least one runner is temporarily fastened at least during its final movement to the damper by magnetic attraction between the magnetic elements.

16. The sliding door device according to claim 2, wherein the intermediate part substantially completely fills a volume between the core part and the rim part.

17. The sliding door device according to claim 2, wherein the core part, the rim part and the spokes are integrally manufactured from the same thermoplastic material.

18. The sliding door device according to claim 3, wherein the core part, the rim part and the spokes are integrally manufactured from the same thermoplastic material.
